(19) United States
(12) Patent Application Publication
(10) Pub. No.: US 2014/0057065 A1
(43) Pub. Date: Feb. 27, 2014

(54) TOUCH PANEL AND TOUCH DISPLAY APPARATUS USING SAME

(71) Applicant: TIANJIN FUNAYUANCHUANG TECHNOLOGY CO.,LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,951

(22) Filed: Aug. 22, 2013

(30) Foreign Application Priority Data
Aug. 24, 2012 (CN) 2012103046101

(51) Int. Cl. G06F 3/041

(52) U.S. Cl. CPC G06F 3/041
USPC 428/58; 428/57

(57) ABSTRACT

A touch panel includes a first sub-panel and a second sub-panel. One of the first sub-panel and the second sub-panel comprises a first carbon nanotube (CNT) film. Each of the first sub-panel and the second sub-panel defines a touch sensing region and a first side region connecting a first side of the touch sensing region. The first side region of the first sub-panel covers the first side region of the second sub-panel such that the touch sensing region of the first sub-panel and the touch sensing region of the second sub-panel are joined via the first side region of the first sub-panel.

### CROSS-REFERENCE TO RELATED APPLICATIONS

This application claims all benefits accruing under 35 U.S.C. §119 from China Patent Application No. 201210304610.1, filed on Aug. 24, 2012 in the China Intellectual Property Office, the content of which is hereby incorporated by reference in its entirety. This application is related to commonly-assigned applications entitled, “CARBON NANOTUBE TOUCH PANEL AND TOUCH DISPLAY APPARATUS USING SAME” filed ______ (Atty. Docket No. US46684), “CARBON NANOTUBE TOUCH PANEL HAVING TWO CARBON NANOTUBE FILMS” filed ______ (Atty. Docket No. US46691), “CARBON NANOTUBE TOUCH PANEL HAVING AT LEAST TWO CARBON NANOTUBE FILMS” filed ______ (Atty. Docket No. US46692), “CARBON NANOTUBE TOUCH PANEL AND METHOD FOR MAKING SAME” filed ______ (Atty. Docket No. US46693), “TOUCH PANEL AND TOUCH DISPLAY APPARATUS USING SAME” filed ______ (Atty. Docket No. US46695), and “TOUCH PANEL AND TOUCH DISPLAY APPARATUS USING SAME” filed ______ (Atty. Docket No. US46960).

### BACKGROUND

1. Technical Field

The present disclosure relates to touch sensing technologies, and more particularly, to a touch panel with at least one carbon nanotube (CNT) film and a touch display apparatus using the touch panel.

2. Description of Related Art

Touch display apparatuses normally include a display assembly and a touch panel attached to the display assembly. Carbon nanotube (CNT) touch panels are widely used because of the durability of CNT touch panels. A CNT touch panel includes a plurality of carbon nanotubes arranged in parallel on a substrate. However, conductivity of the carbon nanotubes decrease as a length of the CNT unit increases. This characteristic is a limit in design, and making a CNT touch panel with a large size is problematic.

What is needed is to provide a means that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a schematic view of a touch panel according to a first embodiment of the present disclosure.

FIG. 2 is an exploded view of the touch panel of FIG. 1.

FIG. 3 is a detailed plan view of the touch panel of FIG. 2.

FIG. 4 is a schematic view of a CNT film of the touch panel of FIG. 1.

FIG. 5 is a schematic view of a touch panel according to a second embodiment of the present disclosure.

FIG. 6 is an exploded and detailed plan view of the touch panel of FIG. 5.

FIG. 7 is a detailed plan view of a touch panel according to a third embodiment of the present disclosure, the touch panel including a first sub-panel and a second sub-panel.

FIG. 8 is an exploded view of the first sub-panel of FIG. 7.

FIG. 9 is an exploded view of the second sub-panel of FIG. 7.

FIG. 10 is a plan view of a conductive layer of the first sub-panel or the second sub-panel of a touch panel according to an alternative embodiment of the present disclosure.

FIG. 11 is a schematic view of a touch display apparatus according to an embodiment of the present disclosure.

### DETAILED DESCRIPTION

Reference will be made to the drawings to describe various embodiments.

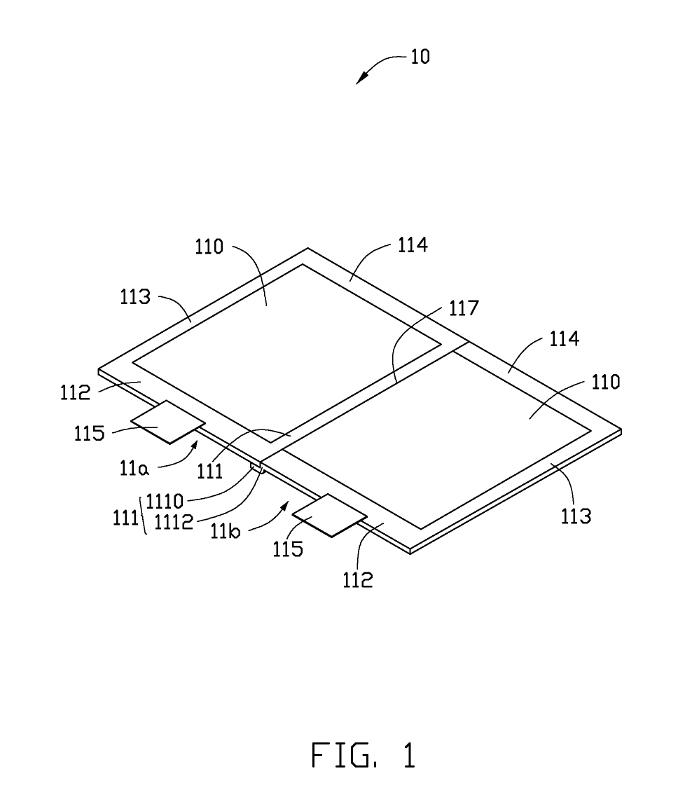

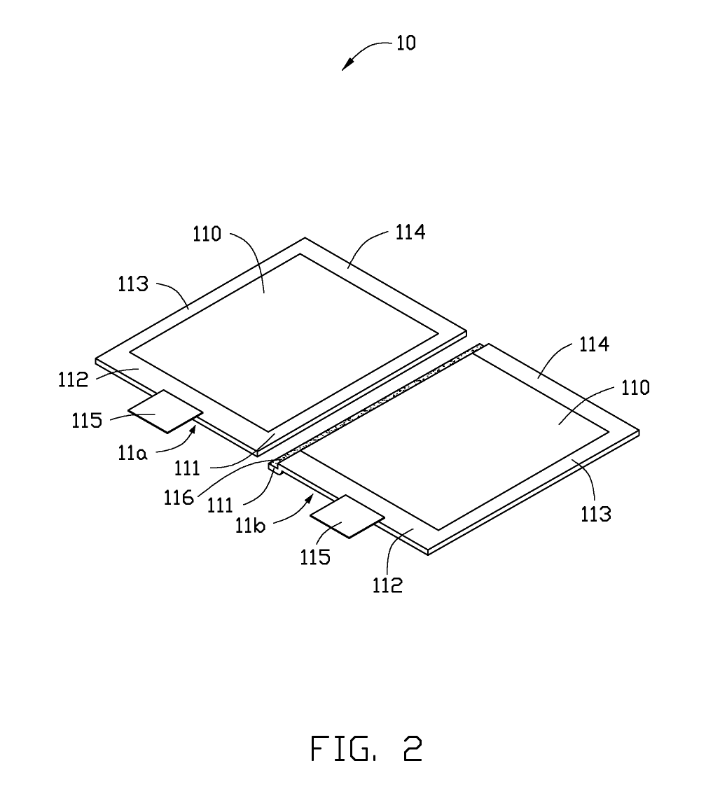

Referring to FIGS. 1-2, a touch display apparatus 10 according to a first embodiment of the present disclosure includes a first sub-panel 11a and a second sub-panel 11b. In the embodiment, both of the first sub-panel 11a and the second sub-panel 11b are CNT touch panels and include a CNT film.

Each of the first sub-panel 11a and the second sub-panel 11b includes a touch sensing region 110, a first side region 111, a second side region 112, a third side region 113, a fourth side region 114 and a flexible printed circuit (FPC) 115. The touch sensing region 110 is located in a main central region of the CNT sub-panel 11a or 11b. The first side region 111, the second side region 112, a third side region 113, and the fourth side region 114 are connected four sides of the touch sensing region 110 respectively. The first side region 111, the second side region 112, a third side region 113, and the fourth side region 114 are arranged end to end to form a periphery region surrounding the touch sensing region 110. The FPC 115 is mounted on and electrically connected to an edge of the second side region 112. The first side region 111 and the third side region 113 are located adjacent to two opposite ends of the touch sensing region 110. The second side region 112 and the fourth side region 114 are located adjacent to the other two opposite ends of the touch sensing region 110.

The first side region 111 of the first sub-panel 11a covers the first side region 111 of the second sub-panel 11b, such that the touch sensing region 110 of the first sub-panel 11a and the touch sensing region 110 of the second sub-panel 11b are joined via the first side region 111 of the first sub-panel 11a. In detail, the first side region 111 of the second sub-panel 11b includes a supporting portion 1110 and a connection portion 1112 connected between the supporting portion 1110 and the touch sensing region 110 of the second sub-panel 11b. The first side region 111 of the first sub-panel 11a is positioned on the supporting portion 1110 and adhered to the supporting portion 1110 by an adhesive layer 116. The touch sensing region 110 of the first sub-panel 11a, the first side region 111 of the first sub-panel 11a and the touch sensing region 110 of the second sub-panel 11b are positioned on a same plane. Moreover, the second side region 112 of the first sub-panel 11a and the second side region 112 of the second sub-panel 11b are positioned on the same plane and joined, and the fourth side region 114 of the first sub-panel 11a and the fourth side region 114 of the second sub-panel 11b are positioned on the same plane and joined.

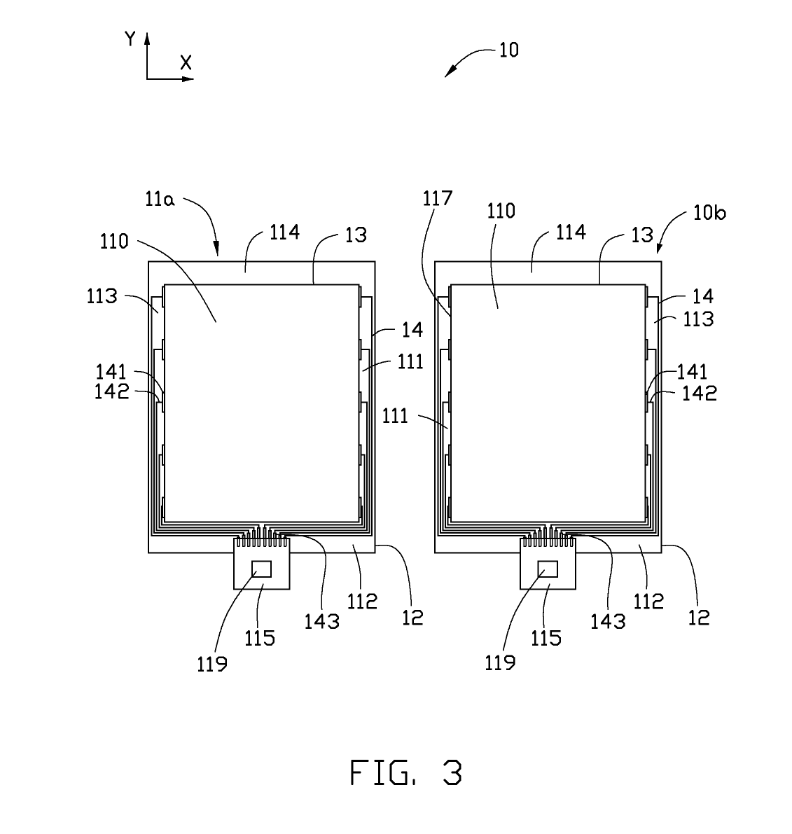

FIG. 3 shows that a detailed plan view of the touch panel 10 before the first side region 111 of the first sub-panel 11a is attached to the first side region 111 of the second sub-panel 11b. It can be understood, the first CNT sub-panel 11a has a configuration substantially the same as the second CNT sub-panel 11b, but differs in that a location of the first side region 111 and the third side region 113 in the first sub-panel 11a is opposite to a location of the first side region 111 and the third side region 113 in the second sub-panel 11b. For example, in the first sub-panel 11a, the first side region 111 is located in a right side of the touch sensing region 110, and the third side region 113 is located in a left side of the touch sensing region 110. In the second sub-panel 11b, the first side region 111 is located in a left side of the touch sensing region 110, and the third side region 113 is located in a right side of the touch sensing region 110.

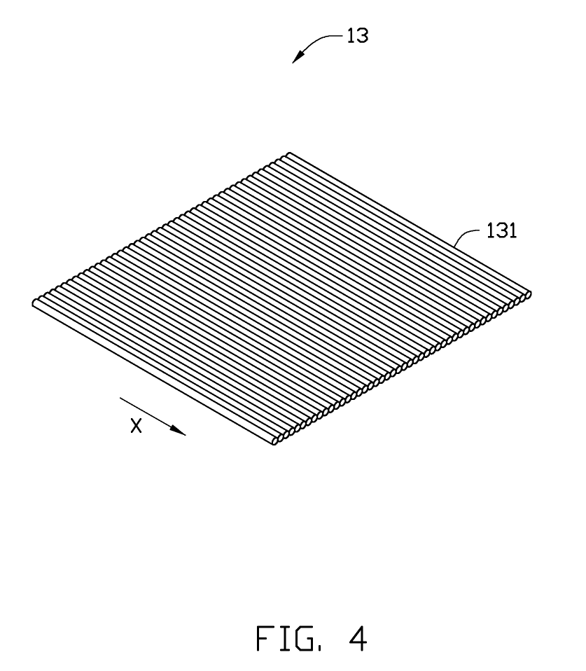

Each of the first sub-panel 11a and the second sub-panel 11b further includes a base 12 and a plurality of connection wires 14. The CNT film 13 is positioned on the base 12 and covers the touch sensing region 110. Referring to FIG. 4, the CNT film 13 includes a plurality of carbon nanotubes 131 orderly arranged, and the plurality of carbon nanotubes 131 are arranged along a first direction X. The touch sensing region 110 includes a side line 117 adjacent to the first side region 111, and the side line 117 is parallel to a second direction Y perpendicular to the first direction X.

The plurality of connection wires 14 are positioned on the periphery region surrounding the touch sensing region 110 and are electrically coupled between the CNT film 13 and the FPC 115. Each connection wire 14 includes a first electrode 141 electrically connected to the CNT film 13, a second electrode 143 electrically connected to the FPC 115, and a first connection portion 142 connected between the first electrode 141 and the second electrode 143. In the embodiment, the first electrodes 141 are positioned on the first side region 111 and the third side region 113, and the second electrodes 142 are positioned on the second side region 112. Moreover, the first electrodes 141 positioned on the first side region 111 are arranged along the second direction Y one by one, the first electrodes 141 positioned on the third side region 113 are arranged along the second direction Y one by one, and the second electrodes 142 positioned on the second side region 112 are arranged along the first direction X one by one.

Referring also to FIG. 1, the touch sensing region 110 of the first sub-panel 11a and the touch sensing region 110 of the second sub-panel 11b are joined to form a large touch sensing region of the touch panel 10. The second side region 112 of the first sub-panel 11a and the second side region 112 of the second sub-panel 11b are joined, and the two FPCs 115 extend out from a same side of the touch panel 10.

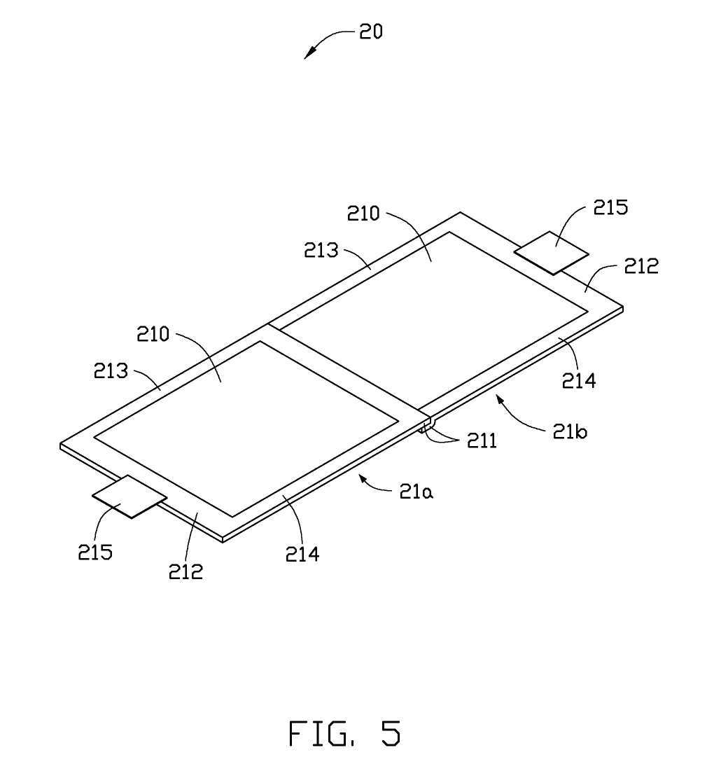

FIG. 5 shows that a schematic view of a touch panel 20 according to a second embodiment of the present disclosure. The touch panel 20 includes a first sub-panel 21a and a second sub-panel 21b. In the embodiment, both of the first sub-panel 21a and the second sub-panel 21b are CNT touch panels and include a CNT film.

Each of the first sub-panel 21a and the second sub-panel 21b includes a touch sensing region 110, a first side region 211, a second side region 212, a third side region 213, a fourth side region 214 and a flexible printed circuit (FPC) 215. The touch sensing region 210 is located in a main central region of the CNT sub-panel 21a or 21b. The first side region 211, the second side region 212, a third side region 213, and the fourth side region 214 are connected four sides of the touch sensing region 210 respectively, and The first side region 211, the second side region 212, a third side region 113, and the fourth side region 214 are arranged end to end to form a periphery region surrounding the touch sensing region 210. The FPC 215 is mounted on and electrically connected to an edge of the second side region 212. The first side region 211 and the second side region 212 are located adjacent to two opposite ends of the touch sensing region 210. The third side region 213 and the fourth side region 214 are located adjacent to the other two opposite ends of the touch sensing region 210.

The first side region 211 of the first sub-panel 21a covers the first side region 211 of the second sub-panel 21b, such that the touch sensing region 210 of the first sub-panel 21a and the touch sensing region 210 of the second sub-panel 21b are joined via the first side region 211 of the first sub-panel 21a.

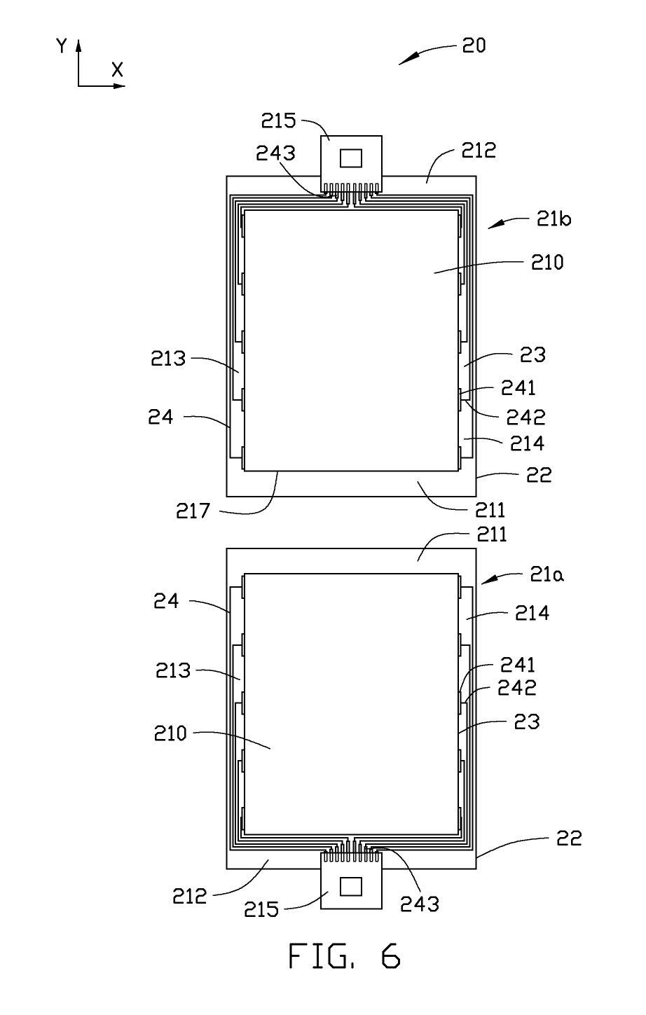

FIG. 6 shows that a detailed plan view of the touch panel 20 before the first side region 211 of the first sub-panel 21a is attached to the first side region 211 of the second sub-panel 21b. The first CNT sub-panel 21a has a configuration substantially the same as the second CNT sub-panel 21b, but differs in that a location of the first side region 211 and the second side region 213 in the first sub-panel 21a is opposite to a location of the first side region 211 and the second side region 212 in the second sub-panel 21b. For example, in the first sub-panel 21a, the first side region 211 is located in an upper side of the touch sensing region 210, and the second side region 212 is located in a lower side of the touch sensing region 210. In the second sub-panel 21b, the first side region 211 is located in a lower side of the touch sensing region 210, and the second side region 212 is located in an upper side of the touch sensing region 210.

Each of the first sub-panel 21a and the second sub-panel 21b further includes a base 22 and a plurality of connection wires 24. The CNT film 23 is positioned on the base 22 and covers the touch sensing region 210. Referring also to FIG. 4, The CNT film 23 may also include a plurality of carbon nanotubes orderly arranged, and the plurality of carbon nanotubes are arranged along the first direction X. The touch sensing region 210 of the second sub-panel 21b further includes a side line 217 connecting the first side region 211 of the second sub-panel 21b, and the side line 217 extends along a first direction X.

The plurality of connection wires 24 are positioned on the periphery region surrounding the touch sensing region 210 and are electrically coupled between the CNT film 23 and the FPC 215. Each connection wire 24 includes a first electrode 241 electrically connected to the CNT film 23, a second electrode 243 electrically connected to the FPC 215, and a first connection portion 242 connected between the first electrode 241 and the second electrode 243. In the second embodiment, the first electrodes 241 are positioned on the third side region 213 and the fourth side region 214, and the second electrodes 242 are positioned on the second side region 212. Moreover, the first electrodes 241 positioned on the third side region 213 are arranged along the second direction Y, the first electrodes 141 positioned on the fourth side region 214 are arranged along the second direction Y, and the second electrodes 242 positioned on the second side region 212 are arranged along the first direction X.

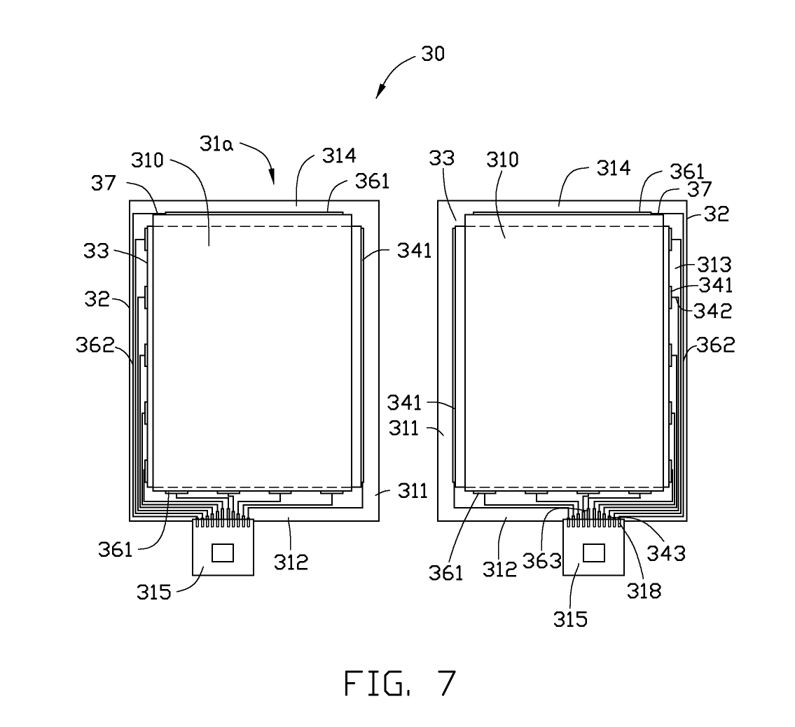

Referring to FIG. 7, a detailed plan view of a touch panel 30 according to a third embodiment includes a first sub-panel 31a and a second sub-panel 31b. The touch panel 30 is similar to the above-described touch panel 10 according to the first embodiment, but differs in detail structures of the first sub-panel 31a and second sub-panel 31b are different from the first sub-panel 11a and second sub-panel 11b according to the first embodiment.

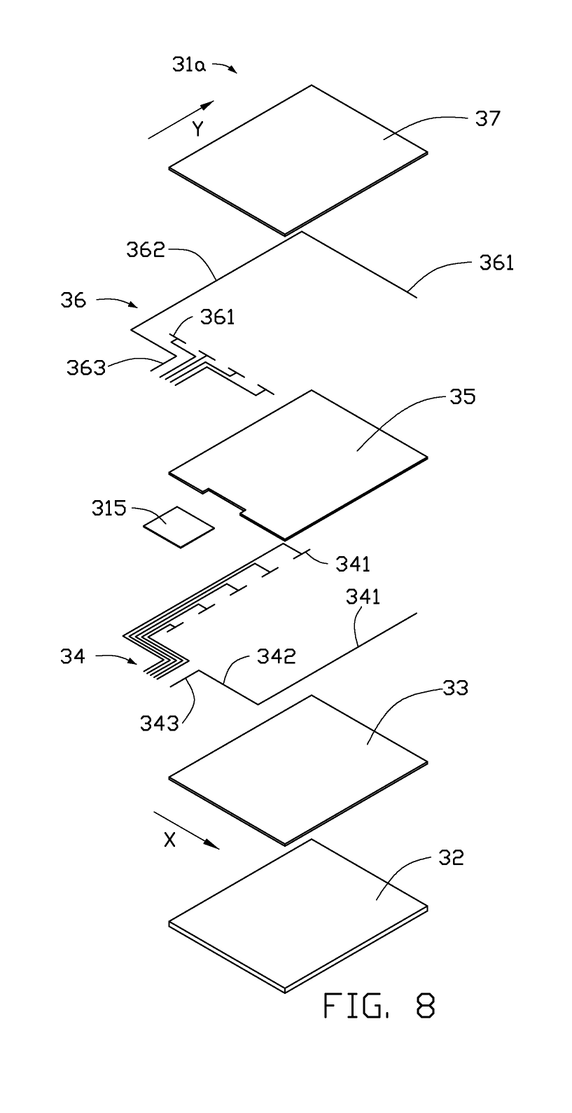

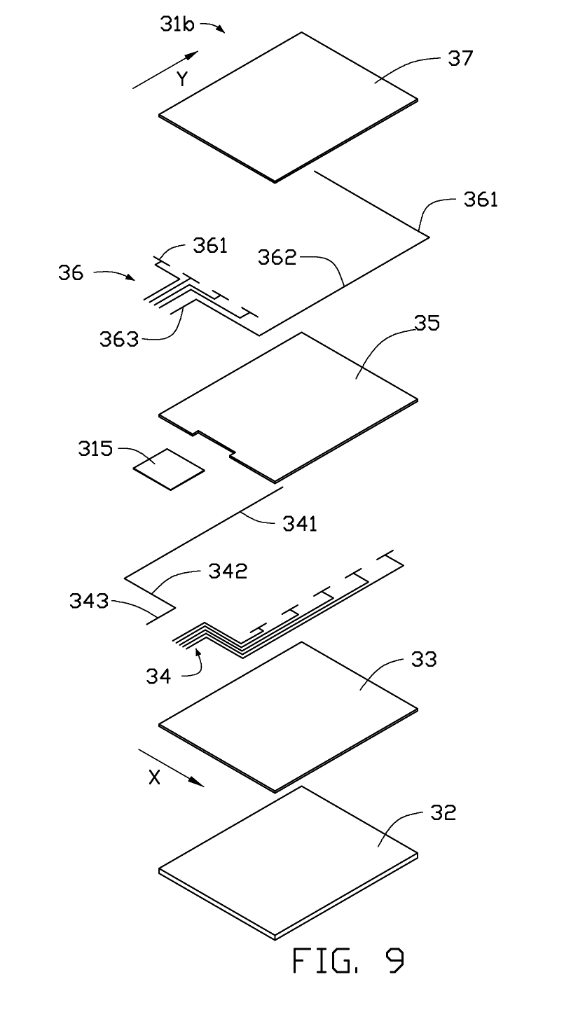

Referring to FIG. 8 and FIG. 9, exploded views of the first sub-panel 31a and second sub-panel 31b are shown. Each of the first sub-panel and the second sub-panel includes a base 32, a first CNT film 33, a plurality of first connection wires 34, an insulation layer 35, a transparent conductive layer 37, and a plurality of second connection wires 36. The base 32 may be a transparent glass substrate or a transparent plastic substrate. The first CNT film 33 is positioned on the base 32. The first connection wires 34 are configured to electrically connect between the first CNT film 33 and the FPC 315. The second connection wires 36 are configured to electrically connect between the transparent conductive layer 37 and the FPC 315. The insulation layer 35 is sandwiched between the first CNT film 33 and the transparent conductive layer 37, such that the first CNT film 33 and the transparent conductive layer 37 coordinately define a capacitance-type touch sensing structure.

In the embodiment, the transparent conductive layer 37 is a second CNT film. Referring to FIG. 4, each of the first CNT film 33 and the second CNT film of transparent conductive layer 37 includes a plurality of carbon nanotubes 131 orderly arranged along a same direction. In detail, each carbon nanotube 131 of the first CNT film 33 extends along a first direction X, and each carbon nanotube 131 of the first CNT film 33 extends along a second direction Y perpendicular to the first direction X.

Referring to FIG. 7, the first CNT sub-panel 31a has a configuration substantially the same as the second CNT sub-panel 31b, but differs in that a location of the first side region 311 and the third side region 313 in the first sub-panel 31a is opposite to a location of the first side region 311 and the third side region 313 in the second sub-panel 31b. For example, in the first sub-panel 31a, the first side region 311 is located in a right side of the touch sensing region 310, and the third side region 313 is located in a left side of the touch sensing region 310. In the second sub-panel 31b, the first side region 311 is located in a left side of the touch sensing region 310, and the third side region 313 is located in a right side of the touch sensing region 310.

Both of the first CNT film 33 and the transparent conductive layer 37 cover the touch sensing region 310. The plurality of first connection wires 34 are positioned on the periphery region surrounding the touch sensing region 310 and are electrically coupled between the first CNT film 33 and the FPC 315. The plurality of second connection wires 36 are positioned on the periphery region surrounding the touch sensing region 310 and are electrically coupled between the transparent conductive layer 37 and the FPC 315.

Each first connection wire 34 includes a first electrode 341 electrically connected to the first CNT film 33, a second electrode 343 electrically connected to the FPC 315, and a first connection portion 342 connected between the first electrode 341 and the second electrode 343. In the embodiment, the first electrodes 341 are positioned on the first side region 311 and the third side region 313, and the second electrodes 342 are positioned on the second side region 312. In the embodiment, the first side region 311 has a first electrode 341 arranged along the second direction Y, and the first electrode 311 of the first side region 311 extends from an end of the first side region 311 to the opposite end of the first side region 311. The third side region 313 has a plurality of first electrodes 341 arranged along the second direction Y. The second side region 312

Each second connection wire 36 includes a third electrode 361 electrically connected to the transparent conductive layer 37, a fourth electrode 363 electrically connected to the FPC 315, and a second connection portion 362 connected between the third electrode 361 and the fourth electrode 363. In the embodiment, the third electrodes 361 are positioned on the second side region 312 and the fourth side region 314, and the fourth electrodes 363 are positioned on the second side region 312. In the embodiment, the second side region 312 includes a plurality of third electrodes 361 arranged along the first direction X. The fourth side region 314 has a third electrode 361 extending along the first direction X, and the third electrode 361 of the fourth side region 314 extends from an end of the fourth side region 314 to the opposite end of the fourth side region 314.

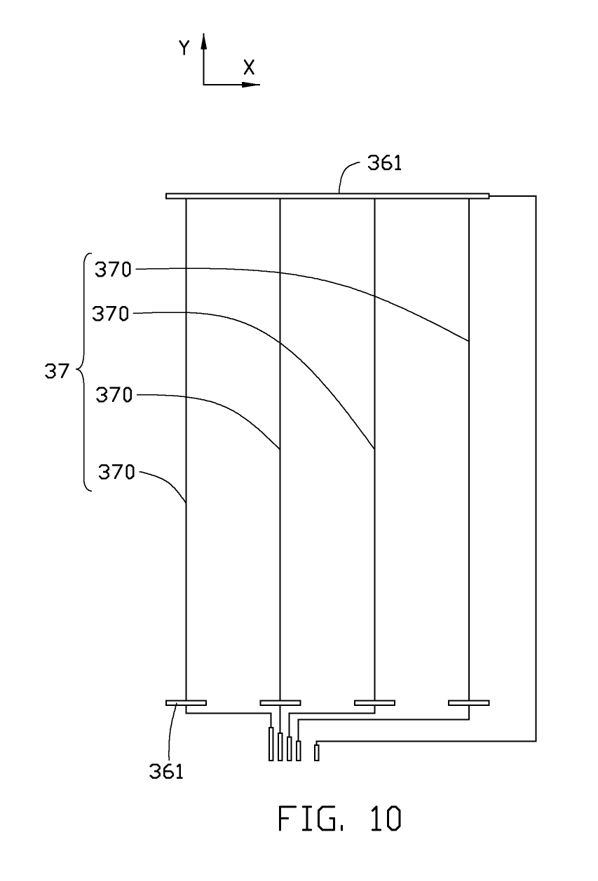

FIG. 10 shows that a structure of a transparent conductive layer 37 of the first sub-panel 31a or the second sub-panel 31b of a touch panel 30 according to an alternative embodiment. In the alternative embodiment, the transparent conductive layer 37 may be not a CNT film, but includes a plurality of transparent electrodes 370 each extending along the second direction Y. The transparent electrodes 370 are made from indium tin oxide (ITO) or indium zinc oxide (IZO). One end of the transparent electrode 370 is electrically connected to the third electrode 361 of the fourth side region 341, and the other end of the transparent electrode 370 is electrically connected to the third electrode 361 of the second side region 312.

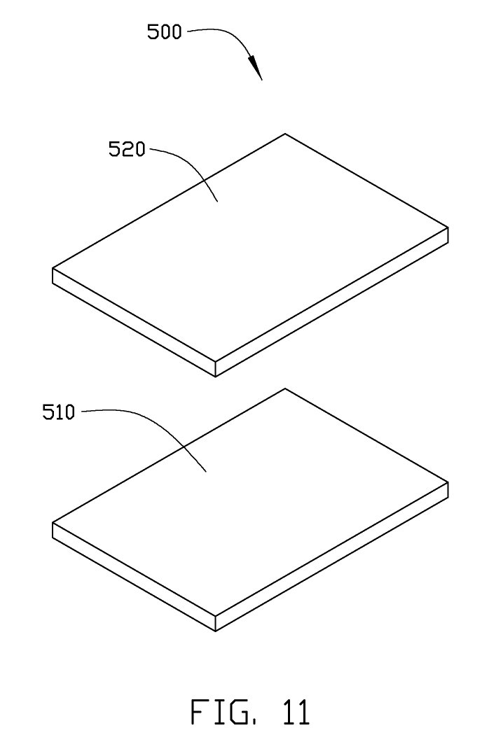

FIG. 11 shows that a touch display apparatus 500 according to an embodiment of the present disclosure. The touch display apparatus 500 includes a display panel 510 and a touch panel 520 positioned above the display panel 510. The touch panel 520 may be adopted the above touch panel 10, 20 and 30. The display panel 520 may be a liquid crystal display (LCD) panel, an organic light Emitting diode (OLED) display panel or a plasma display panel (PDP).

It is to be understood that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts, within the principles of the embodiments, to the full extent indicated by the broad general meaning of the terms in which the appended claims are expressed.

What is claimed is:

1. A touch panel, comprising:
a first sub-panel and
a second sub-panel;
wherein one of the first sub-panel and the second sub-panel comprises a first carbon nanotube (CNT) film, each of the first sub-panel and the second sub-panel defines a touch sensing region and a first side region connecting a first side of the touch sensing region, the first side region of the first sub-panel covers the first side region of the second sub-panel such that the touch sensing region of the first sub-panel and the touch sensing region of the second sub-panel are joined via the first side region of the first sub-panel.

2. The touch panel of claim 1, wherein the first side region of the first sub-panel is adhered to the first side region of the second sub-panel by an adhesive layer.

3. The touch panel of claim 1, wherein the first side region of the second sub-panel comprises a supporting portion and a connection portion connected between the supporting portion and the touch sensing region of the second sub-panel, the first side region of the first sub-panel is positioned on the supporting portion, and the touch sensing region of the first sub-panel, the first side region of the first sub-panel and the touch sensing region of the second sub-panel are positioned on a same plane.

4. The touch panel of claim 1, wherein each of the first sub-panel and the second sub-panel defines second side region connecting a second side of the touch sensing region, a third side region connecting a third side of the touch sensing region, and a fourth side region connecting a fourth side of the touch sensing region, and each of the first sub-panel and the second sub-panel further comprising a flexible printed circuit (FPC) electrically connecting the second side region.

5. The touch panel of claim 4, wherein each of the first sub-panel and the second sub-panel comprises a base, a first CNT film and at least one first connection wire, the first CNT film comprises a plurality of carbon nanotubes orderly arranged along a first direction, and the at least one first connection wire comprises a first electrode connecting the first CNT film, a second electrode connecting the FPC, the first, second, third and fourth side regions are jointed end to end and form a peripheral region surrounding the touch sensing region, and a first connection portion connected between the first electrode and the second electrode.

6. The touch panel of claim 5, wherein the first side region is positioned opposite to the second side region, the third side region is positioned opposite to the fourth side region, the third side region of the first sub-panel and the third side region of the second sub-panel are joined, and the fourth side region of the first sub-panel and the fourth side region of the second sub-panel are joined together.

7. The touch panel of claim 6, wherein the at least on first connection wire comprises a plurality of first connection wires, where each of the third side region and the fourth side region comprises a plurality of first electrodes arranged along a second direction perpendicular to the first direction, and the second side region comprises a plurality of second electrodes arranged along the first direction.

8. The touch panel of claim 5, wherein the first side region is positioned adjacent to the second side region and opposite to the third side region, the second side region is positioned opposite to the fourth side region, the second side region of the first sub-panel and the second side region of the second sub-panel are joined, and the fourth side region of the first sub-panel and the fourth side region of the second sub-panel are joined together.

9. The touch panel of claim 8, wherein the touch region of the second sub-panel comprises a side line connecting the first side region of the second sub-panel, and the side line extends along a second direction perpendicular to the first direction.

10. The touch panel of claim 9, wherein the at least one first connection wire comprises a plurality of first connection wires, the first electrodes of the plurality of first connection wires are positioned in the first side region and the third side region, and the second electrodes of the plurality of first connection wires are positioned in the second side region.

11. The touch panel of claim 10, wherein the first side region comprises a plurality of first electrodes arranged along the second direction, the third side region comprises a plurality of first electrodes arranged along the second direction, and the second side region comprises a plurality of second electrodes arranged along the first direction.

12. The touch panel of claim 10, wherein each of the first sub-panel and the second sub-panel comprises a transparent conductive layer and at lest one second connection wire, the first CNT film and the transparent conductive layer coordinately define a touch sensing structure covering the touch sensing region, and the at least one second connection wire is electrically connected between the transparent conductive layer and FPC.

13. The touch panel of claim 12, wherein the transparent conductive layer is a second CNT film, and the second CNT film comprises a plurality of carbon nanotubes orderly arranged along the second direction.

14. The touch panel of claim 12, wherein the transparent conductive layer comprises a plurality of transparent electrodes each extending along the second direction.

15. The touch panel of claim 14, wherein the transparent electrodes are made from indium tin oxide (ITO) or indium zinc oxide (IZO).

16. The touch panel of claim 12, wherein the at lest one second connection wire comprises a plurality of second connection wires, each second connection wire comprises a third electrode connecting the transparent conductive layer, a fourth electrode connecting the FPC, and a second connection portion connected between the third electrode and the fourth electrode, the third electrodes of the plurality of second connection wires are located in the second side region and the fourth side region, the fourth electrodes of the plurality of second connection wires are located in the second side region.

17. The touch panel of claim 16, wherein the first side region comprises a first electrode arranged along the second direction and extending from an end of the first side region to the opposite end of the first side region, the third side region comprises a plurality of first electrodes arranged along the second direction, and the second side region comprises a plurality of third electrodes arranged along the first direction.

18. The touch panel of claim 17, wherein the fourth side region comprises a third electrode arranged along the first direction and extending from an end of the fourth side region to the opposite end of the fourth side region.

19. The touch panel of claim 18, wherein the second connection portion connected to the third electrode of the fourth side region is located in the fourth, the third and the second side region.

20. A touch display apparatus, comprising:
a display panel; and
a touch panel positioned above the display panel, the touch panel comprising:
a first sub-panel and
a second sub-panel;
wherein one of the first sub-panel and the second sub-panel comprises a first carbon nanotube (CNT) film, each of the first sub-panel and the second sub-panel defines a touch sensing region and a first side region connecting a first side of the touch sensing region, the first side region of the first sub-panel covers the first side region of the second sub-panel such that the touch sensing region of the first sub-panel and the touch sensing region of the second sub-panel are joined via the first side region of the first sub-panel.
